(19) United States
(12) Patent Application Publication
(10) Pub. No.: US 2021/0334647 A1
(43) Pub. Date: Oct. 28, 2021

(54) METHOD, ELECTRONIC DEVICE, AND COMPUTER PROGRAM PRODUCT FOR DETERMINING OUTPUT OF NEURAL NETWORK

(71) Applicant: EMC IP Holding Company LLC, Hopkinton, MA (US)

(72) Inventors: Jiacheng Ni, Shanghai (CN); Jinpeng Liu, Shanghai (CN); Zhen Jia, Shanghai (CN); Qiang Chen, Shanghai (CN)

(21) Appl. No.: 16/892,796

(22) Filed: Jun. 4, 2020

(30) Foreign Application Priority Data
Apr. 26, 2020 (CN) 202010340845.0

(51) Int. Cl. G06N 3/08; G06N 3/04

(52) U.S. Cl. CPC G06N 3/08; G06N 3/04

(57) ABSTRACT

Embodiments of the present disclosure relate to a method, an electronic device, and a computer program product for determining an output of a neural network. A method for determining an output of a neural network includes acquiring a feature vector outputted by at least one hidden layer of the neural network and a plurality of weight vectors associated with a plurality of candidate outputs of the neural network, corresponding probabilities of the plurality of candidate outputs being determined based on the plurality of weight vectors and the feature vector; converting the plurality of weight vectors into a plurality of binary sequences respectively, and converting the feature vector into a target binary sequence; determining a binary sequence most similar to the target binary sequence from the plurality of binary sequences; and determining the output of the neural network from the plurality of candidate outputs based on the binary sequence.

### RELATED APPLICATION(S)

The present application claims priority to Chinese Patent Application No. 202010340845.0, filed Apr. 26, 2020, and entitled “Method, Electronic Device, and Computer Program Product for Determining Output of Neural Network,” which is incorporated by reference herein in its entirety.

### FIELD

Embodiments of the present disclosure generally relate to the field of machine learning, and specifically, to a method, an electronic device, and a computer program product for determining an output of a neural network.

### BACKGROUND

In machine learning applications, a neural network model can be trained based on a training data set, and then a reasoning task is executed using the trained neural network model. Taking an image classification application as an example, a neural network model may be trained based on training images annotated with an image category. Then, a reasoning task can determine a category of an input image using the trained neural network.

When deploying a complex deep neural network (DNN) to a device with limited computing resources and/or memory resources, a model compression technology can be applied to save the memory resources and computing time consumed by a reasoning task. Conventional DNN compression technologies are focused on compressing a feature extraction layer such as a convolutional layer (also known as “hidden layer”). However, in an application such as the above-mentioned image classification application, the category of an input image may be one of a large number of candidate categories, which may result in a very large computing workload of an output layer of a DNN.

### SUMMARY

Embodiments of the present disclosure provide a method, an electronic device, and a computer program product for determining an output of a neural network.

In a first aspect of the present disclosure, a method for determining an output of a neural network is provided. The method includes: acquiring a feature vector outputted by at least one hidden layer of the neural network and a plurality of weight vectors associated with a plurality of candidate outputs of the neural network, corresponding probabilities of the plurality of candidate outputs being determined based on the plurality of weight vectors and the feature vector; converting the plurality of weight vectors into a plurality of binary sequences respectively, and converting the feature vector into a target binary sequence; determining a binary sequence most similar to the target binary sequence from the plurality of binary sequences; and determining the output of the neural network from the plurality of candidate outputs based on the binary sequence.

In a second aspect of the present disclosure, an electronic device is provided. The electronic device includes at least one processing unit and at least one memory. The at least one memory is coupled to the at least one processing unit and stores instructions for execution by the at least one processing unit. The instructions, when executed by the at least one processing unit, cause an apparatus to execute actions. The actions include: acquiring a feature vector outputted by at least one hidden layer of a neural network and a plurality of weight vectors associated with a plurality of candidate outputs of the neural network, corresponding probabilities of the plurality of candidate outputs being determined based on the plurality of weight vectors and the feature vector; converting the plurality of weight vectors into a plurality of binary sequences respectively, and converting the feature vector into a target binary sequence; determining a binary sequence most similar to the target binary sequence from the plurality of binary sequences; and determining an output of the neural network from the plurality of candidate outputs based on the binary sequence.

In a third aspect of the present disclosure, a computer program product is provided. The computer program product is tangibly stored in a non-transitory computer storage medium and includes machine-executable instructions. The machine-executable instructions, when executed by a device, cause the device to execute any step of the method described according to the first aspect of the present disclosure.

This Summary is provided to introduce the selection of concepts in a simplified form, which will be further described in the Detailed Description below. The Summary is neither intended to identify key features or necessary features of the present disclosure, nor intended to limit the scope of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same components.

FIG. 1 shows a block diagram of an example environment in which embodiments of the present disclosure can be implemented;

FIG. 2 shows a schematic diagram of an example deep neural network according to an embodiment of the present disclosure;

FIG. 3 shows a flowchart of an example method for determining an output of a neural network according to an embodiment of the present disclosure;

FIG. 4 shows a schematic diagram of converting an input vector into a binary sequence according to an embodiment of the present disclosure; and

FIG. 5 shows a block diagram of an example electronic device that may be configured to implement the embodiments of the present disclosure.

In the accompanying drawings, the same or corresponding numerals represent the same or corresponding parts.

### DETAILED DESCRIPTION

Illustrative embodiments of the present disclosure will be described in more detail below with reference to the accompanying drawings. Although illustrative embodiments of the present disclosure are shown in the accompanying drawings, it should be understood that the present disclosure can be implemented in various forms and should not be limited to the embodiments set forth herein. Rather, these embodiments are provided to make the present disclosure more thorough and complete, and can fully convey the scope of the present disclosure to those skilled in the art.

The term “include” and variants thereof used herein indicate open-ended inclusion, i.e., “including, but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

As used herein, a “neural network” is capable of processing an input and providing a corresponding output, and generally includes an input layer, an output layer, and one or more hidden layers between the input layer and the output layer. The neural network used in a deep learning application usually includes many hidden layers, thereby lengthening the depth of the network. Therefore, it is also referred to as “deep neural network.” Layers of a neural network are connected in sequence, so that an output from one layer is provided as an input to a next layer, where the input layer receives an input to the neural network, and an output from the output layer is used as a final output from the neural network. Each layer of the neural network includes one or more nodes (also referred to as processing nodes or neurons), and each node processes an input from the last layer. Herein, the terms “neural network,” “network,” and “neural network model” can be used interchangeably.

In machine learning applications, a neural network model can be trained based on a training data set, and then a reasoning task can be executed using the trained neural network model. Taking an image classification application as an example, a neural network model may be trained based on training images annotated with an image category. For example, an annotated image category may indicate what kind of objects (such as human, animal, or plant) a training image describes. Then, a reasoning task can determine a category of an input image using the trained neural network, e.g., identifying what kind of objects (such as human, animal, or plant) the input image describes.

When deploying a complex deep neural network (DNN) to a device with limited computing resources and/or memory resources, a model compression technology can be applied to save the memory resources and computing time consumed by a reasoning task. Conventional DNN compression technologies are focused on compressing a feature extraction layer such as a convolutional layer (also known as a “hidden layer”). However, in an application such as the above-mentioned image classification application, the category of an input image may be one of a large number of candidate categories, which may result in a very large computing workload of an output layer of a DNN.

Embodiments of the present disclosure present a solution for determining an output of a neural network, to solve the above problem and one or more of other potential problems. The solution converts a computation executed by an output layer of a neural network into a maximum inner product search (MIPS) problem, and obtains an approximate solution to the MIPS problem using locality-sensitive hashing (LSH). In this way, the solution can compress the output layer of the neural network, and save the memory resources and computing time consumed by the output layer of the neural network, thereby improving the computation efficiency of the output layer.

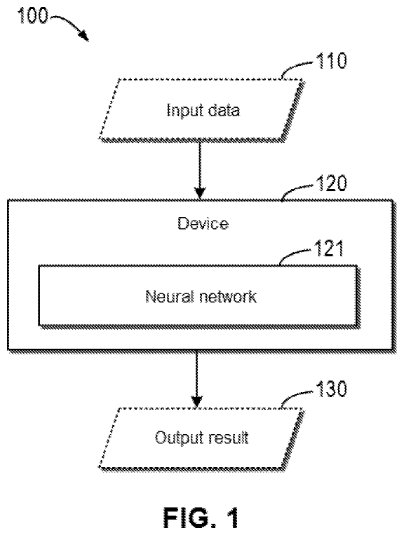

FIG. 1 shows a block diagram of example environment 100 in which embodiments of the present disclosure can be implemented. It should be understood that the structure and function of environment 100 are described for illustrative purposes only, and do not imply any limitation to the scope of the present disclosure. For example, embodiments of the present disclosure may also be applied in an environment different from environment 100.

As shown in FIG. 1, environment 100 includes device 120 that is provided with trained neural network 121. Device 120 can receive input data 110 and generate output result 130 using neural network 121. Taking an image classification application as an example, neural network 121 can be trained based on training images annotated with an image category. For example, an annotated image category may indicate a type of an object (such as human, animal, or plant) described in a training image. Input data 110 may be an input image, and output result 130 may indicate a category of the input image, for example, a type of an object described in the input image, such as human, animal, or plant.

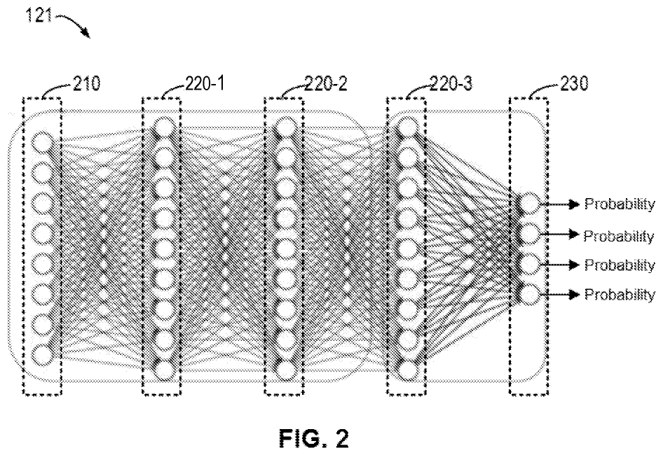

FIG. 2 shows a schematic diagram of neural network 121 according to an embodiment of the present disclosure. As shown in FIG. 2, neural network 121 may include input layer 210, hidden layers 220-1, 220-2, and 220-3 (collectively or individually referred to as “hidden layers 220” or “feature extraction layers 220”), and output layer 230. Layers of neural network 121 are connected in sequence, where an output from one layer is provided as an input to a next layer. Each layer of the neural network includes one or more nodes (also referred to as processing nodes or neurons), and each node processes an input from the last layer. Input layer 210 may receive input data 110 of neural network 121. Taking an image classification application as an example, input data 110 received by input layer 210 may be an input image. Output layer 230 may include a plurality of output nodes to output corresponding probabilities that the input image is of different categories, e.g., a probability that the input image involves a person, a probability that the input image involves an animal, and a probability that the input image involves a plant. Assuming that among a plurality of probabilities outputted by the plurality of output nodes of output layer 230, the probability that the input image involves a person is the highest, then output result 130 of neural network 121 may indicate that an object described in the input image is a person.

In some embodiments, device 120 shown in FIG. 1 may be an edge device or terminal device in the Internet of Things (IoT), and has limited computing resources and/or memory resources. In order to save the memory resources and computing time consumed when neural network 121 executes a reasoning task, device 120 may compress neural network 121. For example, device 120 may compress one or more hidden layers 220 and/or output layer 230 of neural network 121.

In some embodiments, in order to compress output layer 230 of neural network 121, device 120 can convert a computation executed by output layer 230 of neural network 121 into a maximum inner product search (MIPS) problem, and obtain an approximate solution to the MIPS problem using locality-sensitive hashing (LSH).

Specifically, assuming that a feature vector outputted by the last hidden layer 220-3 of neural network 121 is expressed as x=[x₁, . . . , x_{d}], where d denotes a dimension of the feature vector and d≥1. A probability outputted by the j-th output node is expressed as zⱼ, where zⱼ=wⱼ^{T}·x, wⱼ denotes a weight vector associated with the j-th output node, and a dimension of the weight vector is d. The computation executed by output layer 230 of neural network 121 can be considered as solving the following MIPS problem: argmaxⱼ(wⱼ^{T}·x), i.e., finding the output node j that maximizes wⱼ^{T}·x.

LSH is a hash-based algorithm for identifying an approximate nearest neighbor. In a common nearest neighbor problem, there may be a plurality of points (also referred to as a training set) in a space, and the goal is to, for a given new point, identify a point closest to the given new point in the training set. A complexity of this process is usually linear, i.e., O (N), where N is the number of points in the training set. The approximate nearest neighbor algorithm attempts to reduce the complexity to sublinear (less than linear). By reducing the number of comparisons required to find similar items, a sublinear complexity can be achieved. The working principle of LSH is as follows: if there are two points close to each other in a feature space, they are very likely to have the same hash value (a simplified representation of data). The main difference between LSH and conventional hashing is that conventional hashing tries to avoid a conflict, while LSH is intended to maximize a conflict between similar points. In conventional hashing, a minor disturbance to an input will significantly change a hash value of the input. However, in LSH, minor disturbances will be ignored to easily identify main content. Hash conflicts result in a high probability that similar items have the same hash value.

In some embodiments, device 120 can obtain an approximate solution to the above MIPS problem using LSH, thereby saving the memory resources and computing time consumed by output layer 230 of neural network 121, and improving the computation efficiency of output layer 230.

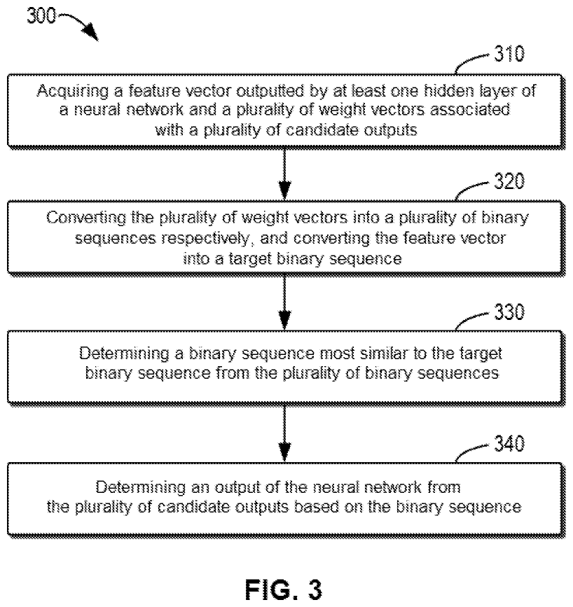

FIG. 3 shows a flowchart of example method 300 for determining an output of a neural network according to an embodiment of the present disclosure. Method 300 may be executed, e.g., by device 120 shown in FIG. 1. It should be understood that method 300 may further include an additional action that is not shown and/or may omit an action that is shown. The scope of the present disclosure is not limited in this regard. Method 300 is described in detail below in combination with FIG. 1 and FIG. 2.

As shown in FIG. 3, in block 310, device 120 acquires a feature vector outputted by at least one hidden layer 220 of neural network 121 and a plurality of weight vectors associated with a plurality of candidate outputs of neural network 121. Corresponding probabilities of the plurality of candidate outputs are determined based on a product of the plurality of weight vectors and the feature vector.

In some embodiments, device 120 can acquire feature vector x=[x₁, . . . , x_{d}] from the last hidden layer 220-3 prior to output layer 230 of neural network 121, where d denotes a dimension of the feature vector and d≥1. For each output node j among a plurality of output nodes of output layer 230 of neural network 121, device 120 can acquire a weight vector wⱼ associated with the output node j, and its dimension is also d.

In block 320, device 120 converts the plurality of weight vectors into a plurality of binary sequences respectively, and converts the feature vector into a target binary sequence.

In some embodiments, for each weight vector wⱼ among the plurality of weight vectors, device 120 can normalize the weight vector wⱼ: P(wⱼ)=[wⱼ; \sqrt{1−∥wⱼ∥₂²}; 0], where ∥P(wⱼ)∥=1. Device 120 can project the normalized weight vector into a k-dimensional space to obtain a k-dimensional projection vector, where k is less than d. That is, device 120 can convert a d-dimensional weight vector into a k-dimensional projection vector by dimension reduction. In some embodiments, device 120 can generate the k-dimensional projection vector by multiplying a projection matrix by the normalized weight vector. The projection matrix may be a matrix with k lines and d rows for projecting a d-dimensional vector into a k-dimensional space. In some embodiments, k×d elements in the projection matrix can be independently extracted from a Gaussian distribution (e.g., the mean is 0 and the variance is 1). Then, device 120 can convert each projection value among k projection values of the projection vector into a binary number (i.e., 0 or 1), thereby obtaining a binary sequence corresponding to the weight vector wⱼ. In some embodiments, if the projection value exceeds a preset threshold (e.g., 0), device 120 can convert the projection value into 1; if the projection value does not exceed the preset threshold (e.g., 0), device 120 can convert the projection value into 0.

Similarly, device 120 can normalize the feature vector x=[x₁, . . . , x_{d}]: Q(x)=[x; \sqrt{1−∥x∥₂²}; 0], where ∥Q(x)∥=1. Device 120 can project the normalized feature vector into a k-dimensional space to obtain a k-dimensional projection vector, where k is less than d. That is, device 120 can convert a d-dimensional feature vector into a k-dimensional projection vector by dimension reduction. Then, device 120 can convert each projection value among k projection values of the projection vector into a binary number (i.e., 0 or 1), thereby obtaining a binary sequence corresponding to the feature vector. For example, if the projection value exceeds a preset threshold (e.g., 0), device 120 can convert the projection value into 1; if the projection value does not exceed the preset threshold (e.g., 0), device 120 can convert the projection value into 0.

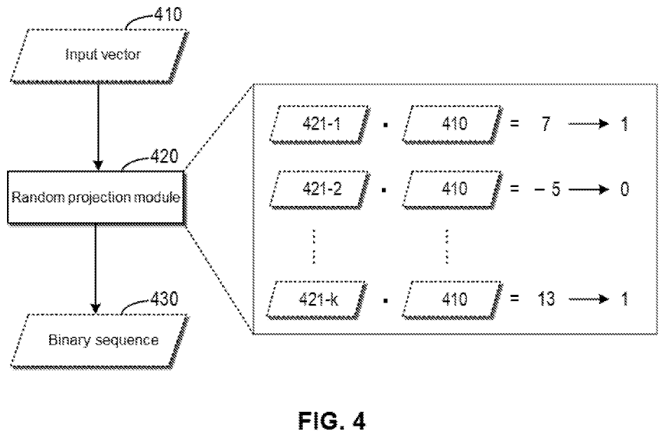

FIG. 4 shows a schematic diagram of converting an input vector into a binary sequence according to an embodiment of the present disclosure. As shown in FIG. 4, input vector 410 may be a normalized weight vector wⱼ or a feature vector x. Input vector 410 may be inputted to random projection module 420 and then converted into binary sequence 430. Random projection module 420 may be implemented, e.g., in device 120 shown in FIG. 1.

In some embodiments, random projection module 420 can generate a projection vector including k projection values by multiplying a projection matrix by input vector 410. The projection matrix may be a matrix with k lines and d rows, and each line may be regarded as a d-dimensional random vector. As shown in FIG. 4, the projection matrix may include, e.g., random vectors 421-1, 421-2, . . . , 421-k (collectively or individually referred to as “random vectors 421”). Each random vector 421 is dot-multiplied by input vector 410 to obtain a projection value. In some embodiments, for each projection value of the k projection values, if the projection value exceeds a preset threshold (e.g., 0), random projection module 420 can convert the projection value into 1; if the projection value does not exceed the preset threshold (e.g., 0), random projection module 420 can convert the projection value into 0. In this way, random projection module 420 can convert d-dimensional input vector 410 into binary sequence 430 with a length of k. Herein, binary sequence 430 is also referred to as a hash value of input vector 410.

Returning to FIG. 3, in block 330, device 120 determines a binary sequence most similar to the target binary sequence from the plurality of binary sequences corresponding to the plurality of weight vectors. In some embodiments, device 120 can determine a Euclidean distance from each binary sequence among the plurality of binary sequences to the target binary sequence. Device 120 can determine a binary sequence most similar to the target binary sequence from the plurality of binary sequences, where the Euclidean distance from the binary sequence to the target binary sequence is the smallest.

In block 340, device 120 determines an output of the neural network from a plurality of candidate outputs based on the determined binary sequence. In some embodiments, device 120 can determine a weight vector corresponding to the binary sequence from the plurality of weight vectors. Device 120 can select a candidate output associated with the weight vector from the plurality of candidate outputs (i.e., the plurality of output nodes) as output 130 of neural network 121.

As can be seen from the above description, the embodiments of the present disclosure provide a solution for determining an output of a neural network. The solution converts a computation executed by an output layer of a neural network into a maximum inner product search (MIPS) problem, and obtains an approximate solution to the MIPS problem using locality-sensitive hashing (LSH). The solution can reduce a feature dimension of samples to be searched for using LSH (i.e., reducing from d dimensions to k dimensions), and can obtain an approximate solution to the MIPS problem under a sublinear complexity.

Experimental data shows that the solution can significantly reduce the computing workload of an output layer of a neural network with a small amount of accuracy loss, thereby saving the memory resources and computing time consumed by the output layer of the neural network, and improving the computation efficiency of the neural network. Therefore, with the solution, a complex neural network (e.g., a DNN) can be deployed on a device with limited computing resources and/or memory resources, e.g., an edge device or terminal device in the IoT.

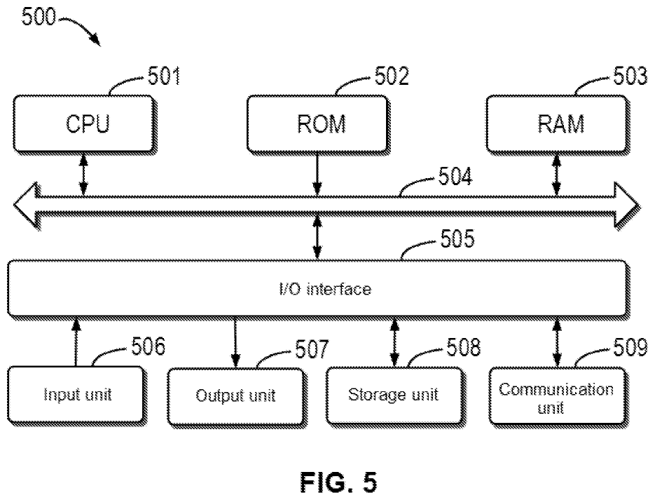

FIG. 5 shows a block diagram of example electronic device 500 that may be configured to implement the embodiments of the present disclosure. For example, device 120 as shown in FIG. 1 may be implemented by electronic device 500. As shown in FIG. 5, device 500 includes central processing unit (CPU) 501 that may execute various appropriate actions and processing in accordance with computer program instructions stored in read-only memory (ROM) 502 or computer program instructions loaded onto random access memory (RAM) 503 from storage unit 508. In RAM 503, various programs and data required for the operation of device 500 may also be stored. CPU 501, ROM 502, and RAM 503 are connected to each other through bus 504. Input/output (I/O) interface 505 is also connected to bus 504.

A plurality of components in device 500 are connected to I/O interface 505, including: input unit 506, such as a keyboard and a mouse; output unit 507, such as various types of displays and speakers; storage unit 508, such as a magnetic disk and an optical disk; and communication unit 509, such as a network card, a modem, and a wireless communication transceiver. Communication unit 509 allows device 500 to exchange information/data with other devices via a computer network such as the Internet and/or various telecommunication networks.

The processes and processing described above, such as method 300, may be executed by processing unit 501. For example, in some embodiments, method 300 may be embodied as a computer software program that is tangibly included in a machine-readable medium, such as storage unit 508. In some embodiments, some or all of the computer program can be loaded and/or installed onto device 500 via ROM 502 and/or communication unit 509. When the computer program is loaded into RAM 503 and executed by CPU 501, one or more actions of method 300 described above may be executed.

Illustrative embodiments of the present disclosure include a method, an apparatus, a system, and/or a computer program product. The computer program product may include a computer-readable storage medium with computer-readable program instructions for executing various aspects of the present disclosure loaded thereon.

The computer-readable storage medium may be a tangible device that can retain and store instructions for use by an instruction-executing device. Examples of the computer-readable storage medium may include, but are not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, RAM, ROM, an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punch card or a protruding structure within a groove with instructions stored thereon, and any suitable combination thereof. The computer-readable storage medium used herein is not construed as transient signals themselves, such as radio waves or other freely propagating electromagnetic waves, electromagnetic waves propagating through waveguides or other transmission media (e.g., optical pulses through fiber-optic cables), or electrical signals transmitted through electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages. The programming languages include object-oriented programming languages, such as Smalltalk and C++, and conventional procedural programming languages, such as “C” language or similar programming languages. The computer-readable program instructions may be executed completely on a user's computer, executed partially on a user's computer, executed as a separate software package, executed partially on a user's computer and partially on a remote computer, or executed completely on a remote computer or a server. In the case where a remote computer is involved, the remote computer can be connected to a user's computer through any kind of networks, including a local area network (LAN) or a wide area network (WAN), or can be connected to an external computer (e.g., connected through the Internet using an Internet service provider). In some embodiments, an electronic circuit, such as a programmable logic circuit, a field programmable gate array (FPGA), or a programmable logic array (PLA), is customized by utilizing state information of computer-readable program instructions. The electronic circuit may execute the computer-readable program instructions to implement various aspects of the present disclosure.

Various aspects of the present disclosure are described here with reference to the flowcharts and/or block diagrams of the method, the apparatus (system), and the computer program product according to the embodiments of the present disclosure. It should be understood that each block in the flowcharts and/or block diagrams as well as a combination of blocks in the flowcharts and/or block diagrams may be implemented by using computer-readable program instructions.

These computer-readable program instructions can be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flowcharts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture that includes instructions for implementing various aspects of the functions/actions specified in one or more blocks in the flowcharts and/or block diagrams.

The computer-readable program instructions may also be loaded onto a computer, another programmable data processing apparatus, or another device, such that a series of operation steps are performed on the computer, another programmable data processing apparatus, or another device to produce a computer-implemented process. Thus, the instructions executed on the computer, another programmable data processing apparatus, or another device implement the functions/actions specified in one or more blocks in the flowcharts and/or block diagrams.

The flowcharts and block diagrams in the accompanying drawings show the architectures, functions, and operations of possible implementations of the system, the method, and the computer program product according to a plurality of embodiments of the present disclosure. In this regard, each block in the flowcharts or block diagrams may represent a module, a program segment, or a part of an instruction that includes one or more executable instructions for implementing specified logical functions. In some alternative implementations, the functions marked in the blocks may also occur in an order different from that marked in the accompanying drawings. For example, two successive blocks may actually be performed basically in parallel, or they may be performed in an opposite order sometimes, depending on the functions involved. It should be further noted that each block in the block diagrams and/or flowcharts as well as a combination of blocks in the block diagrams and/or flowcharts may be implemented by using a dedicated hardware-based system for executing specified functions or actions or by a combination of dedicated hardware and computer instructions.

Illustrative embodiments of the present disclosure have been described above. The above description is illustrative, rather than exhaustive, and is not limited to the disclosed embodiments. Numerous modifications and alterations are apparent to those of ordinary skill in the art without departing from the scope and spirit of illustrated various embodiments. The selection of terms used herein is intended to best explain the principles and practical applications of the embodiments or the improvements to technologies on the market, and to otherwise enable persons of ordinary skill in the art to understand the embodiments disclosed herein.

What is claimed is:

1. A method for determining an output of a neural network, comprising:
acquiring a feature vector outputted by at least one hidden layer of the neural network and a plurality of weight vectors associated with a plurality of candidate outputs of the neural network, corresponding probabilities of the plurality of candidate outputs being determined based on the plurality of weight vectors and the feature vector;
converting the plurality of weight vectors into a plurality of binary sequences respectively, and converting the feature vector into a target binary sequence;
determining a binary sequence most similar to the target binary sequence from the plurality of binary sequences; and
determining the output of the neural network from the plurality of candidate outputs based on the binary sequence.

2. The method according to claim 1, wherein the plurality of weight vectors comprises a first weight vector, and converting the plurality of weight vectors into the plurality of binary sequences respectively comprises:
normalizing the first weight vector comprising a first number of weight values;
generating, by projecting the normalized first weight vector into a space having a second number of dimensions, a first projection vector comprising the second number of projection values, the second number being less than the first number; and
generating a first binary sequence corresponding to the first weight vector by converting each projection value in the first projection vector into a binary number.

3. The method according to claim 2, wherein generating the first projection vector comprises:
generating the first projection vector by multiplying a projection matrix by the normalized first weight vector, the projection matrix being used for projecting a vector having the first number of dimensions into the space.

4. The method according to claim 3, wherein elements in the projection matrix follow a Gaussian distribution.

5. The method according to claim 2, wherein converting each projection value in the first projection vector into a binary number comprises:
converting the projection value into a first binary number if the projection value exceeds a preset threshold; and
converting the projection value into a second binary number different from the first binary number if the projection value does not exceed the preset threshold.

6. The method according to claim 2, wherein converting the feature vector into the target binary sequence comprises:
normalizing the feature vector comprising the first number of feature values;
generating a second projection vector by projecting the normalized feature vector into the space, the second projection vector comprising the second number of projection values; and
generating the target binary sequence by converting each projection value in the second projection vector into a binary number.

7. The method according to claim 1, wherein determining the binary sequence most similar to the target binary sequence from the plurality of binary sequences comprises:
determining a Euclidean distance from each binary sequence among the plurality of binary sequences to the target binary sequence; and
determining the binary sequence having the smallest Euclidean distance from the target binary sequence from the plurality of binary sequences.

8. The method according to claim 1, wherein determining the output of the neural network from the plurality of candidate outputs comprises:
determining a weight vector corresponding to the binary sequence from the plurality of weight vectors; and
selecting a candidate output associated with the weight vector from the plurality of candidate outputs as the output of the neural network.

9. The method according to claim 1, wherein the neural network is a deep neural network deployed in an Internet-of-things device.

10. An electronic device, comprising:
at least one processing unit; and
at least one memory coupled to the at least one processing unit and storing instructions for execution by the at least one processing unit, wherein the instructions, when executed by the at least one processing unit, cause the electronic device to execute actions comprising:
acquiring a feature vector outputted by at least one hidden layer of a neural network and a plurality of weight vectors associated with a plurality of candidate outputs of the neural network, corresponding probabilities of the plurality of candidate outputs being determined based on the plurality of weight vectors and the feature vector;
converting the plurality of weight vectors into a plurality of binary sequences respectively, and converting the feature vector into a target binary sequence;
determining a binary sequence most similar to the target binary sequence from the plurality of binary sequences; and
determining an output of the neural network from the plurality of candidate outputs based on the binary sequence.

11. The electronic device according to claim 10, wherein the plurality of weight vectors comprises a first weight vector, and converting the plurality of weight vectors into the plurality of binary sequences respectively comprises:
normalizing the first weight vector comprising a first number of weight values;
generating, by projecting the normalized first weight vector into a space having a second number of dimensions, a first projection vector comprising the second number of projection values, the second number being less than the first number; and
generating a first binary sequence corresponding to the first weight vector by converting each projection value in the first projection vector into a binary number.

12. The electronic device according to claim 11, wherein generating the first projection vector comprises:
generating the first projection vector by multiplying a projection matrix by the normalized first weight vector, the projection matrix being used for projecting a vector having the first number of dimensions into the space.

13. The electronic device according to claim 12, wherein elements in the projection matrix follow a Gaussian distribution.

14. The electronic device according to claim 11, wherein converting each projection value in the first projection vector into a binary number comprises:
converting the projection value into a first binary number if the projection value exceeds a preset threshold; and
converting the projection value into a second binary number different from the first binary number if the projection value does not exceed the preset threshold.

15. The electronic device according to claim 11, wherein converting the feature vector into the target binary sequence comprises:
normalizing the feature vector comprising the first number of feature values;
generating a second projection vector by projecting the normalized feature vector into the space, the second projection vector comprising the second number of projection values; and
generating the target binary sequence by converting each projection value in the second projection vector into a binary number.

16. The electronic device according to claim 10, wherein determining the binary sequence most similar to the target binary sequence from the plurality of binary sequences comprises:
determining a Euclidean distance from each binary sequence among the plurality of binary sequences to the target binary sequence; and
determining the binary sequence having the smallest Euclidean distance from the target binary sequence from the plurality of binary sequences.

17. The electronic device according to claim 10, wherein determining the output of the neural network from the plurality of candidate outputs comprises:
determining a weight vector corresponding to the binary sequence from the plurality of weight vectors; and
selecting a candidate output associated with the weight vector from the plurality of candidate outputs as the output of the neural network.

18. The electronic device according to claim 10, wherein the neural network is a deep neural network deployed in an Internet-of-things device.

19. A computer program product tangibly stored in a non-transitory computer storage medium and comprising machine-executable instructions, wherein the machine-executable instructions, when executed by a device, cause the device to execute a method for determining an output of a neural network, the method comprising:
acquiring a feature vector outputted by at least one hidden layer of the neural network and a plurality of weight vectors associated with a plurality of candidate outputs of the neural network, corresponding probabilities of the plurality of candidate outputs being determined based on the plurality of weight vectors and the feature vector;
converting the plurality of weight vectors into a plurality of binary sequences respectively, and converting the feature vector into a target binary sequence;
determining a binary sequence most similar to the target binary sequence from the plurality of binary sequences; and
determining the output of the neural network from the plurality of candidate outputs based on the binary sequence.

20. The computer program product according to claim 19, wherein the plurality of weight vectors comprises a first weight vector, and converting the plurality of weight vectors into the plurality of binary sequences respectively comprises:
normalizing the first weight vector comprising a first number of weight values;
generating, by projecting the normalized first weight vector into a space having a second number of dimensions, a first projection vector comprising the second number of projection values, the second number being less than the first number; and
generating a first binary sequence corresponding to the first weight vector by converting each projection value in the first projection vector into a binary number.
